(19) United States
(12) Patent Application Publication
(10) Pub. No.: US 2026/0170406 A1
(43) Pub. Date: Jun. 18, 2026

(54) TABULAR GRAPH LANGUAGE MODEL WITH MULTI-MODAL LEARNING

(71) Applicant: Fujitsu Limited, Kawasaki-shi (JP)

(72) Inventors: Anay MAJEE, DALLAS, TX (US); Maria XENOCHRISTOU, San Francisco, CA (US); Wei-Peng CHEN, Fremont, CA (US)

(73) Assignee: Fujitsu Limited, Kawasaki-shi (JP)

(21) Appl. No.: 18/986,563

(22) Filed: Dec. 18, 2024

(51) Int. Cl. G06N 20/00

(52) U.S. Cl. CPC G06N 20/00

(57) ABSTRACT

According to an aspect of an embodiment, a method may include obtaining a tabular dataset. The tabular dataset may be converted into a first dataset having a first data type using a first converter. The tabular dataset may be converted into a second dataset having a second data type using a second converter. The method may further include generating, using a first encoder, a first set of embeddings in a first dimensional space based on the first dataset and generating, using a second encoder, a second set of embeddings in a second dimensional space based on the second dataset. The method may further include training one or both of the first encoder and the second encoder based on the first set of embeddings and the second set of embeddings.

### FIELD

The embodiments discussed in the present disclosure are related to a multi-modal, graph-language model configured for tabular data.

### BACKGROUND

Tabular datasets often include features including multiple types of data. The quality of understanding of the features by artificial intelligence models may be affected by how well the models understand relationships among the features and the semantic content of the features.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method may include obtaining a tabular dataset. The tabular dataset may be converted into a first dataset having a first data type using a first converter. The tabular dataset may be converted into a second dataset having a second data type using a second converter. The method may further include generating, using a first encoder, a first set of embeddings in a first dimensional space based on the first dataset and generating, using a second encoder, a second set of embeddings in a second dimensional space based on the second dataset. The method may further include training one or both of the first encoder and the second encoder based on the first set of embeddings and the second set of embeddings.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIGS. 1A-1B illustrate an example system configured to implement multi-modal learning or training of artificial intelligence (AI) models, in accordance with at least one embodiment of the present disclosure;

FIG. 2 illustrates a flow chart of an example method of multi-modal training of AI models, arranged in accordance with at least one embodiment of the present disclosure; and

FIG. 3 illustrates a block diagram of an example computing system that may be used with a multi-modal training system, in accordance with one or more embodiments of the present disclosure.

### DESCRIPTION OF EMBODIMENTS

An artificial intelligence (AI) model is an algorithm or a computational system that is configured to perform tasks that may generally require human operations. The AI models may learn patterns, make decisions or predictions, and solve problems by processing data. The performance of AI models may vary based on quality of input data and how well the AI models understand the input data. The input data may be presented or organized in various formats depending on various implementations and/or fields of use.

For example, the input data and/or new data for generating predictions may be organized in tabular format. A tabular dataset is a type of data structure in which data is organized into rows and columns. Each row may represent a data entry, and the columns may represent features or attributes of the data entry. In general, a tabular dataset may include various types of data. For example, a tabular dataset may include numerical data, categorical data, Boolean data, text data, etc. The various types of variables and the formatting of the tabular datasets may help provide data in a structured format that reflects relationships between the features. Such a format may allow the tabular datasets to be used in variety of industries and/or domains.

AI models may be configured to learn the various features of the tabular dataset such that the AI models may generate predictions for new data entries. Tabular datasets may be used for various tasks by the AI models such as classification, regression, clustering, etc. However, performances of the AI models with respect to tabular datasets may be limited in how effectively the AI models understand the various types of data or features included in tabular datasets. For instance, AI models generally learn the data by converting the data into numerical encodings. However, the various types of data included in tabular datasets may present challenges in such conversions. For example, in instances the tabular datasets include data that may be a combination of numerical, categorical, and textual data types, the relationships between the features may confuse the AI model, making it difficult to learn meaningful patterns. Further, jointly learning from different data types in the tabular datasets may be challenging. Additionally, the AI model may have a difficult time identifying the most relevant features and transforming raw data into useful inputs or embeddings for the AI models to learn. The AI models may also experience overfitting, in which the AI models perform well on the training data but fails to generalize to unseen data.

Some existing approaches may include converting the tabular dataset into a dataset having a type of data that may be easier for AI models to understand. For example, the tabular dataset may be converted into a dataset having data types such as image, text, graph, etc. However, such approaches are limited or not effective with respect to understanding both the semantic content of features and the structural relationships between the features in the tabular dataset. For example, converting the tabular dataset to text data may lead to loss of understanding of structural relationships between the features.

According to one or more embodiments of the present disclosure, an AI model may be trained based on a multi-modal learning framework with respect to a tabular dataset. For example, a tabular dataset may be transformed to multiple types or modalities of data. In particular, as described in detail in the present disclosure, the multi-modal learning framework may include transforming and/or converting the tabular dataset to graph data and text data. The multi-model data (e.g., the graph data and the text data) may be aligned. Such alignment may help improve the quality of learning of the tabular dataset by the AI model by leveraging complementary information from multiple modalities.

The AI model trained using the multi-modal data may generate predictions with improved accuracy with respect to newly presented data. The multi-modal learning framework may improve the AI model's ability to model feature heterogeneity across various tasks. For example, the AI model may better understand or learn different types of data present in the tabular dataset, such that more accurate predictions may be generated.

Embodiments of the present disclosure will be explained with reference to the accompanying drawings.

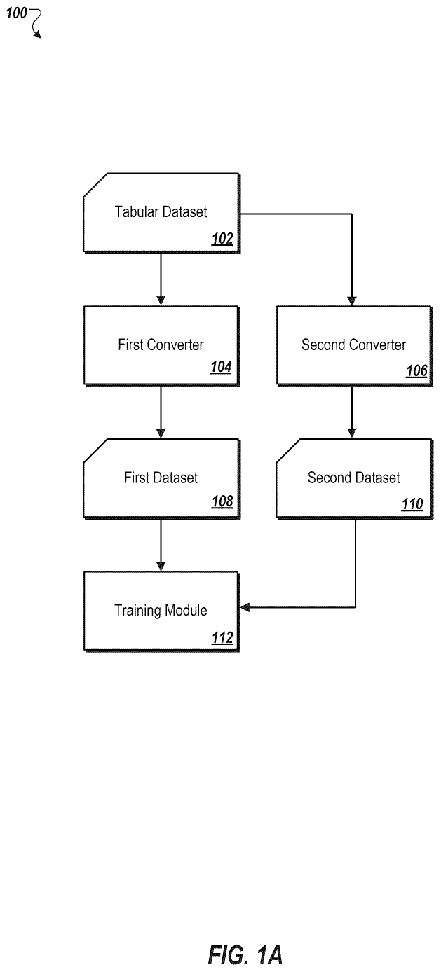

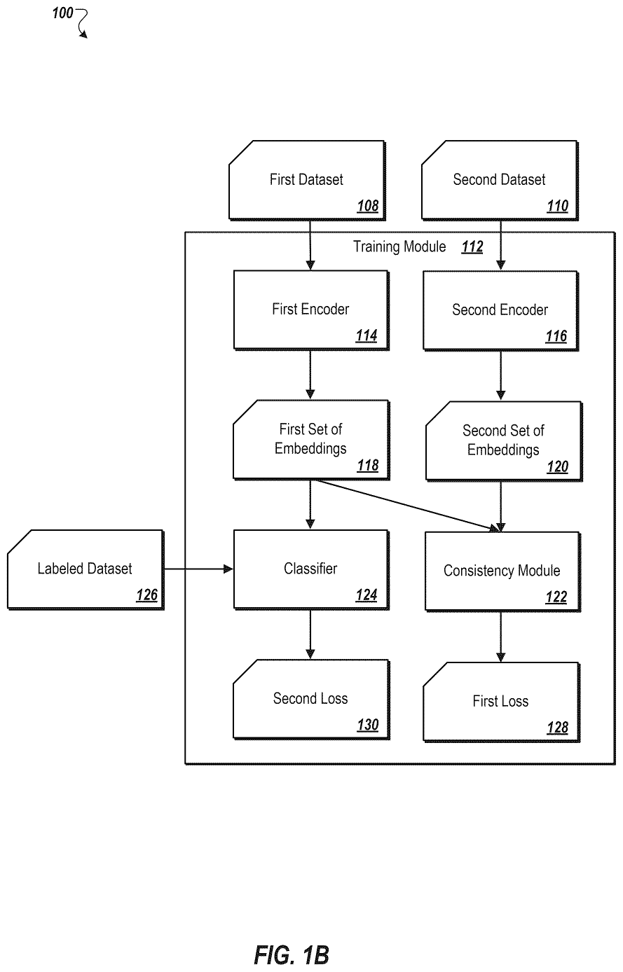

FIG. 1A illustrates an example system 100 configured to implement multi-modal learning or training of artificial intelligence (AI) models, in accordance with one or more embodiments of the present disclosure. In some embodiments, the system 100 may include a first converter 104, a second converter 106, and a training module 112. In general, the system 100 may be configured to train an AI model based on a tabular dataset 102. The tabular dataset 102 may be formatted using rows and columns. Each row may correspond to a unique observation entry or instance in the tabular dataset 102. For example, each row may represent a unique data entry or data point. For example, each row may represent a transaction, a customer, a product, etc. Each column may represent a feature or an attribute of the data. The features may be variables or characteristics that describe each data observation or entry. For example, in instances in which a row represents a customer, the columns may include different variables that describe the customer, such age, gender, medical history, etc. The columns or the variables of the tabular dataset 102 may be of different data type, such as numerical, categorical, Boolean, text, etc. The tabular dataset 102 may be used to train AI models to generate predictions when a new data entry is provided to the AI models.

In some embodiments, the first converter 104 and the second converter 106 may be configured to convert or transform the tabular dataset 102 to different types or modalities of data. In some embodiments, the first converter 104 and the second converter 106 may include code and routines configured to allow a computing system to perform one or more operations corresponding to the first converter 104 and the second converter 106. Additionally or alternatively, the first converter 104 and the second converter 106 may be implemented using hardware including one or more processors, a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Further, reference to operations that are performed by the first converter 104 and the second converter 106 may include operations that the first converter 104 and the second converter 106 causes some other component to perform.

In these and other embodiments, the first converter 104 may generate the first dataset 108, and the second converter 106 may generate the second dataset 110. In these and other embodiments, the first dataset 108 and the second dataset 110 may include different modalities of data from the tabular dataset. Additionally, the first dataset 108 and the second dataset 110 may include different types of data from each other.

For example, in some embodiments, the first dataset 108 may include graph data and the second dataset 110 may include text data. In these and other embodiments, the first converter 104 and the second converter 106 may include any suitable types of converters to transform the tabular dataset 102 into graph data and text data, respectively. While discussed below with respect to graph data and text data, the first dataset 108 and the second dataset 110 may include other modalities.

In some embodiments, the first converter 104 may be configured to generate the first dataset 108 including graph data corresponding to the tabular dataset 102. In some embodiments, the first converter 104 may split the tabular dataset 102 into two disjoint components based on types of data present in different columns of the tabular dataset 102. For example, some columns may include numerical columns while other columns include categorical columns.

In some embodiments, the first converter 104 may include a normalizer and a numerical encoder. The normalizer may be configured to normalize the numerical data of the numerical columns. In these and other embodiments, the normalizer may include any types of suitable normalizer such as a min-max normalizer. The numerical encoder may be configured to convert the categorical data of the categorical columns into numerical encodings. In these and other embodiments, the numerical encoder may include any suitable types of numerical encoders such as a OneHot encoder, ordinal encoders, binary encoders, frequency encoders, target encoders, etc. In these and other embodiments, the numerical encodings and the normalized numerical data may be joined or combined to generate the first dataset 108 including graph data.

For example, in some embodiments, the first dataset 108 may include a set of graphs, in which individual graphs of the set of graphs corresponding to individual rows of the tabular dataset 102. Each graph of the set of graphs may include nodes and edges connecting the nodes. In these and other embodiments, the nodes may represent features or columns associated with the rows, and the edges may represent interaction between the nodes or the columns corresponding to the nodes. In some embodiments, the edges may be weighted, in which the weights represent importance of the relationships between the nodes or the rows.

In some embodiments, the second converter 106 may be configured to generate the second dataset 110 including text data corresponding to the tabular dataset 102. In these and other embodiments, the second dataset 110 may include a set of serialized text data, in which each serialized text of the set of serialized text data represent rows of the tabular dataset 102. In some embodiments, the second converter 106 may include a text tokenizer configured to break down the serialized text into tokens. The tokens may include words, characters, subwords, or phases from the serialized text data.

In some embodiments, the first converter 104 and the second converter 106 may be configured to convert or transform a part or batch of the tabular dataset 102. In these and other embodiments, the first converter 104 and the second converter 106 may convert the same part or batch of the tabular dataset 102. In some embodiments, the batch size may be defined by a user or an operator of the system 100 based on various parameters such as memory availability. For example, the user may reduce the batch size with less memory available for the system 100 and increase the batch size with more memory available.

In some embodiments, the training module 112 may be configured to obtain the first dataset 108 and the second dataset 110. In some embodiments, the training module 112 may include code and routines configured to allow a computing system to perform one or more operations corresponding to the training module 112. Additionally or alternatively, the training module 112 may be implemented using hardware including one or more processors, a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Further, reference to operations that are performed by the training module 112 may include operations that the training module 112 causes some other component to perform.

The training module 112 may be configured to train an AI model based on the first dataset 108 and the second dataset 110. In these and other embodiments, the training module 112 may train the AI model based on multiple modalities of the first dataset 108 and the second dataset 110 (e.g., the graph data and the text data corresponding to the tabular dataset 102) to learn the patterns and content present in the tabular dataset 102. In these and other embodiments, the multiple modalities may allow the training module 112 to train the AI model to understand the tabular dataset 102 more effectively, including both structural and semantic information present in the tabular dataset 102. In some embodiments, the training module 112 may be implemented as part of the AI model. The training module 112 may be discussed in further detail with respect to FIG. 1B.

With reference to FIG. 1B, in some embodiments, the training module 112 may include a first encoder 114 and a second encoder 116. In some embodiments, the first encoder 114 and the second encoder 116 may be configured to obtain the first dataset 108 and the second dataset 110, respectively. The first encoder 114 and the second encoder 116 may be configured to respectively generate a first set of embeddings 118 and a second set of embeddings 120 based on the first dataset 108 and the second dataset 110, respectively.

In these and other embodiments, the first encoder 114 and the second encoder 116 may be or include types of encoders corresponding to the types of data in the first dataset 108 and the second dataset 110, respectively. For example, in instances in which the first dataset 108 includes graph data corresponding to the tabular dataset 102, the first encoder 114 may be or include any types of encoders suitable for generating graph embeddings based on graph data. For example, the first encoder 114 may be or include a graph neural network (GNN) model. For example, the GNN may be trained to generate graph embeddings from the graph data. In some embodiments, the first set of embeddings 118 may be generated in a first dimensional space. The first dimensional space may correspond to the dimensionality or size of the output vector generated from the first set of embeddings 118. In these and other embodiments, the first set of embeddings 118 may represent structural relationships between the features or columns.

In some embodiments, in instances in which the second dataset 110 includes text data corresponding to the tabular dataset 102, the second encoder 116 may be or include any encoders suitable for generating text embeddings based on the text data. For example, the second encoder 116 may include any encoder that may convert text (e.g., words, sentences, paragraphs, etc.) into numerical representations or embeddings that can be processed by AI models.

For example, in some embodiments, the second encoder 116 may be or include a large language model (LLM) encoder configured to encode the serialized text into the second set of embeddings 120 (e.g., text embeddings). The LLM encoder may be trained to be directly used as text encoders. For example, the LLM encoder may be trained to receive text data (e.g., the serialized text) and to generate embeddings capturing the semantic meaning of the input text data. While the second encoder 116 is described with respect to an LLM, any other suitable types of text encoders, such as Word2Vec, GloVe, transformer-based encoders, etc., may be used. In some embodiments, the second encoder 116 may generate the second set of embeddings 120 in a second dimensional space. In some embodiments, the second dimensional space may be same as the first dimensional space. In other embodiments, the second dimensional space may be different from the first dimensional space. The embeddings may include structured vector representation that captures the meaning and context of the text. In the present disclosure, a reference to an LLM may include a reference to the encoder part of the LLM.

In some embodiments, the training module 112 may include a consistency module 122 configured to determine a first loss 128. In some embodiments, the consistency module 122 may be configured to determine the first loss 128 based on the first set of embeddings 118 and the second set of embeddings 120. In these and other embodiments, the first loss 128 may represent distances between the first set of embeddings 118 and the second set of embeddings 120. For instance, individual embeddings of the first set of embeddings 118 and the second set of embeddings 120 that correspond to the same data entry or row of the tabular dataset 102 may be identified, and the distances between the individual embeddings that correspond to the same data entry may be determined.

In some instances, the first dimensional space of the first set of embeddings 118 may be different from the second dimensional space of the second set of embeddings 120. In such instances, the first set of embeddings 118 or the second set of embeddings 120 may be projected to a different dimensional space such that the first set of embeddings 118 and the second set of embeddings 120 are in the same dimensional space. For example, the first set of embeddings 118 may be projected to the second dimensional space or the second set of embeddings 120 may be projected to the first dimensional space, such that the first set of embeddings 118 and the second set of embeddings 120 may be compared in the same dimensional space. In some instances, a modality gap may exist between the first set of embeddings 118 and the second set of embeddings. However, such modality gap may be such that the modality gap may be ignored.

In some embodiments, the training module 112 may include a classifier 124 or a classifier head configured to map the first set of embeddings 118 from the first dimensional space to a third dimensional space. In general, the third dimensional space may be a lower dimensional space compared to the first dimensional space. In some embodiments, the third dimensional space may match the number of classes in a classification task or the dimensional space of a labeled dataset. The labeled dataset 126 may include a set of target class labels. The set of target class labels may represent targets that the AI model is trying to predict. For example, with respect to a classification task, the labeled dataset 126 may include categorical variables that represent categories or classes that the AI model is trying to predict. The target class labels may represent the true or actual categories to which each data point belongs. In these and other embodiments, the labeled dataset 126 may serve as the ground truth.

In these and other embodiments, the classifier 124 may map the first set of embeddings 118 to the labeled dataset 126 to determine a second loss 130. In some embodiments, the second loss 130 may represent the difference between the first set of embeddings 118 and the true vales or the labeled dataset 126. For example, the classifier 124 may generate a prediction from each embedding of the first set of embeddings 118, in which each prediction corresponds to a class. The predicted classes may be compared to the actual class to calculate a cross-entry loss (e.g., the second loss 130). In some embodiments, the classifier 124 may be or include a regression head configured to output a numerical value as the predictions for each embedding of the first set of embeddings 118. In such instances, the second loss 130 may be determined using different techniques, such as calculating mean squared error (MSE). MSE may measure the squared difference between the predictions (e.g., the numerical values) and the true output (e.g., the labeled dataset 126), averaged over all data points. Any other techniques such as specialized loss functions like cross-entropy loss may be used to determine the second loss 130.

In some embodiments, the training module 112 may determine a total loss based on the first loss 128 and the second loss 130. In some embodiments, the total loss may be a sum of the first loss 128 and the second loss 130. In some embodiments, the total loss may be a weighted sum of the first loss 128 and the second loss 130, in which the first loss 128 and the second loss 130 are weighted differently. For example, in some instances, the first loss 128 may be weighted more than the second loss 130 (e.g., 7:3 ratio between the first loss 128 and the second loss 130). In other instances, the second loss 130 may be weighted more than the first loss 128. In some embodiments, the weights between the first loss 128 and the second loss 130 may be defined by a user.

In some embodiments, the training module 112 may be configured to adjust one or more parameters of the first encoder 114 and/or the second encoder 116 to reduce the total loss. In some embodiments, the one or more parameters may include weights of neural network layers. For example, adjusting parameters of the first encoder 114 (e.g., a GNN) may include adjusting weights of different layers of the GNN. In these and other embodiments, the training module 112 may perform gradient calculation to identify how much each parameter contributed to the total loss. For example, the training module 112 may use backpropagation to determine how each parameter contributes to the total loss 130. The gradients may be used to adjust the one or more parameters to reduce or minimize the loss. For instance, the training module 112 may include an optimizer (e.g., stochastic gradient descent (SGD), Adam, etc.) configured to adjust the one or more parameters based on the gradients.

In some embodiments, parameters of only one of the first encoder 114 and the second encoder 116 may be adjusted to reduce the total loss. For example, in some embodiments, parameters of only the first encoder 114 may be adjusted. In some embodiments, the encoder to adjust parameters between the first encoder 114 and the second encoder 116 may be determined based on resources and/or costs associated with training or adjusting parameters of the encoders. For instance, adjusting parameters or training an LLM may require heavy computing resources compared to training a GNN. In such instances, only the GNN or the first encoder 114 may be trained (e.g., parameters adjusted to reduce the total loss).

In some embodiments, the training module 112 may repeat the training process of determining the total loss and reducing the total loss by adjusting the parameters of the one or more encoders. For example, the training process may be repeated until a threshold level of total loss is reached. In some embodiments, the threshold level of the total loss may be defined by the user. In these and other embodiments, the user may define the threshold level based on various parameters such as training cost, data complexity, field of use, etc. Additionally or alternatively, the training process may include other stopping criteria, such as maximum number of iterations or early stopping based on validation performances.

In these and other embodiments, the training process of reducing the total loss may reduce the first loss (between the first set of embeddings 118 and the second set of embeddings 120) and/or the second loss (between the first set of embeddings 118 and the labeled dataset 126). Such training process my improve the accuracy of the AI model by reducing the differences between the first set of embeddings 118 and the second set of embeddings 120 and between the first set of embeddings 118 and the labeled dataset 126. Reducing the first loss between the first set of embeddings 118 and the second set of embeddings 120 may help the AI model to capture both the structural relationships (from the first set of embeddings 118) and the semantic information (from the second set of embeddings 120) present in the tabular dataset 102. Such an AI model may generate predictions that are more accurate than AI models trained based on a single modality (e.g., text, graph, image, etc.).

Modifications, additions, or omissions may be made to the system 100 without departing from the scope of the present disclosure. For example, in some embodiments, the system 100 may include any number of other components that may not be explicitly illustrated or described.

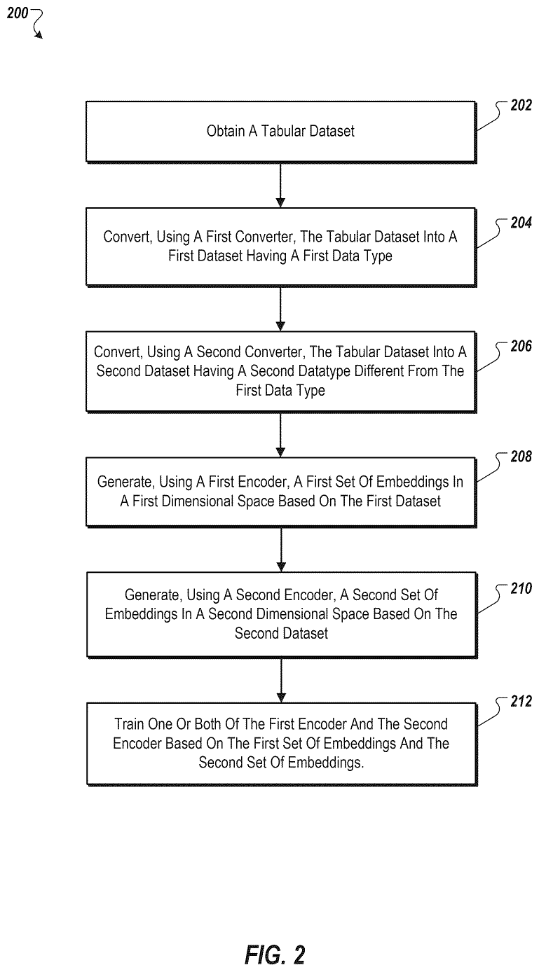

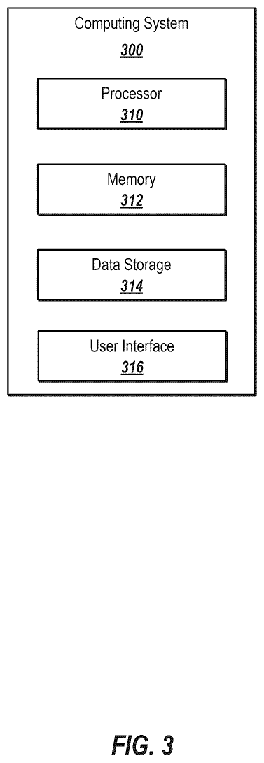

FIG. 2 illustrates a flow diagram of an example method 200 of multi-modal AI model training, in accordance with one or more embodiments of the present disclosure. The method 200 may be performed by any suitable system, apparatus, or device. For example, the method 200 may be implemented using the system 100 of FIGS. 1A-1B or the computing system 300 of FIG. 3. Although illustrated with discrete blocks, the steps and operations associated with one or more blocks of the method 200 may be divided into additional blocks, combined into fewer blocks, or eliminated, depending on the particular implementation.

In some embodiments, the method 200 may begin at block 202. At block 202, a tabular dataset may be obtained. The tabular dataset may include a set of data organized in a tabular format. In some embodiments, the tabular dataset may include data entries including different types of data. For example, the tabular dataset may include numerical data, categorical data, text data, etc. In some embodiments, a user may provide the tabular dataset. In these and other embodiments, the tabular dataset may be a training dataset to train an AI model for a particular purpose defined by the user. For example, a particular AI model may be trained to detect certain medical conditions of a patient. based on a set of variables related to the patient. In such instances, the tabular dataset may include a set of patient records including a presence of the medical conditions.

At block 204, the tabular dataset may be converted, using a first converter, to a first dataset having a first data type. The first converter may include hardware and/or software configured to transform the tabular dataset to the first dataset having the first data type. In some embodiments, the first data type may be different from tabular data. For example, in some embodiments, the first dataset may include graph data. In these and other embodiments, the first converter may include any suitable hardware and/or software that may transform tabular data to graph data.

In these and other embodiments, the first dataset may include a set of graphs generated based on the tabular dataset. For example, in some embodiments, the first dataset may include a graph for each row of the tabular dataset. Each graph may include nodes representing features included in the columns associated with each row. Additionally, each graph may include edges connecting the nodes, in which the edges represent structural relationships between the nodes and/or features corresponding to the nodes. In some embodiments, the edges may be weighted to represent significance or importance of the relationships between the nodes. In some embodiments, the first converter may be described in further detail with respect to the first converter 104 of FIG. 1A.

At block 206, the tabular dataset may be converted, using a second converter, to a second dataset having a second data type. The second converter may include hardware and/or software configured to transform the tabular dataset to the second dataset having the second data type. In some embodiments, the second data type may be different from tabular data and the first data type. For example, in some embodiments, the second dataset may include text data. In these and other embodiments, the second converter may include any suitable hardware and/or software that may transform tabular data to text data.

In these and other embodiments, the second dataset may include a set of serialized texts sentences, in which each sentence represents a row of the tabular dataset. In some embodiments, the second converter may include a text tokenizer configured to break down the serialized text into tokens. The tokens may include words, characters, subwords, or phases from the serialized text data. In some embodiments, the first converter and the second converter may transform a portion or batch of the tabular dataset into the first dataset and the second dataset, respectively. In these and other embodiments, the first converter and the second converter may convert the same portion or the batch of the tabular dataset. In some embodiments, the batch of the tabular dataset to be converted may be defined by the user. In some embodiments, the second converter may be described in further detail with respect to the second converter 106 of FIG. 1A.

At block 208, a first set of embeddings in a first dimensional space may be generated based on the first dataset using a first encoder. The first encoder may include any software and/or hardware suitable to generate the first set of embeddings based on the first dataset. For example, in instances in which the first dataset includes graph data, the first encoder may be or include software and/or hardware configured to generate graph embeddings based on the graph data. For example, in some embodiments, the first encoder may include a GNN model trained to generate graph embeddings based on graph data. In some embodiments, the first encoder may be described in further detail with respect to the first encoder 114 of FIG. 1B.

At block 210, a second set of embeddings in a second dimensional space may be generated based on the second dataset using a second encoder. In some embodiments, the second dimensional space may be the same dimensional space as the first dimensional space. In other embodiments, the second dimensional space may be different from the first dimensional space. The second encoder may include any software and/or hardware suitable to generate the second set of embeddings based on the second dataset. For example, in instances in which the second dataset includes text data, the second encoder may be or include software and/or hardware configured to generate text embeddings based on the text data. For example, in some embodiments, the second encoder may include an LLM (e.g., the encoder part of the LLM). In some embodiments, the second encoder may be described in further detail with respect to the second encoder 116 of FIG. 1B.

At block 212, one or both of the first encoder and the second encoder may be trained based on the first set of embeddings and/or the second set of embeddings. In some embodiments, training the one or both of the first encoder and the second encoder may include adjusting or updating one or more parameters of the first encoder and/or the second encoder.

In some embodiments, a labeled dataset including a set of target labels may be obtained. The target labels may represent values or targets that the AI model is trying to predict. For example, with respect to a classification task, the labeled dataset may include categorical targets that represent categories or classes that the AI model is trying to predict. The target class labels may represent the true or actual categories to which each data point belongs. In these and other embodiments, the labeled dataset may serve as the ground truth.

In these and other embodiments, a first loss between the first set of embeddings and the second set of embeddings may be determined. In some embodiments, the first loss may represent a consistency loss between the first et of embeddings and the second set of embeddings. In some embodiments, determining the first loss may include verifying that the first dimensional space matches the second dimensional space. In instances in which the first dimensional space is different from the second dimensional space, the first set of embeddings may be projected to the second dimensional space. In some embodiments, individual embeddings of the first set of embeddings and the second set of embeddings that correspond to same data point or row of the tabular dataset may be determined, and distances between the corresponding individual embeddings may be calculated to determine the first loss.

In some embodiments, a second loss between the first set of embeddings and the labeled dataset may be determined. In some embodiments, the second loss may represent deviation of the first set of embeddings from the target values or labels. In some embodiments, the first set of embeddings may be projected to a third dimensional space corresponding to the labeled dataset, such that the first set of embeddings and the labeled dataset may be compared. The first set of embeddings may be mapped, using a classifier, to the set of target labels included in the labeled dataset. The second loss may be determined based on the mapping.

In some embodiments, a total loss may be determined based on the first loss and the second loss. In some embodiments, the total loss may be a sum of the first loss and the second loss. In some embodiments, the total loss may be a weighted sum of the first loss and the second loss. For example, the first loss and the second loss may be weighted differently. For instance, the first loss may be weighted more than the second loss. In another instance, the second loss may be weighted more than the first loss. In some embodiments, the weights of the first loss and the second loss may be defined by the user.

In some embodiments, one or more parameters of the one or both of the first encoder and the second encoder may be updated based on the total loss. For example, the one or more parameters may be adjusted or updated such that the total loss may be reduced. In instances in which the first encoder and/or the second encoder includes neural networks such as a GNN, updating the one or more parameters may include updating weights and/or biases of different layers of the neural networks.

In some embodiments, parameters of only one of the first encoder and the second encoder may be adjusted based on the total loss. For example, in some embodiments, the parameters of only the first encoder may be adjusted. In some embodiments, one of the first encoder and the second encoder may be selected to be adjusted based on complexity and/or cost associated with adjusting the parameters. For example, adjusting the parameters of a GNN may be more cost effective than adjusting the parameters of an LLM as the LLM may be more complex or bigger. In such instances, parameters of only the GNN may be adjusted.

In some embodiments, the first set of embeddings and/or the second set of embeddings may be used to train based on the input data. For example, in instances in which the input data only includes text data, the second set of embeddings corresponding to the text encoder (e.g., the second encoder) may be used to train the second encoder. However, in instances in which the input data includes mixed types of data or only numerical data, both the first set of embeddings and the second set of embeddings may be used to train.

Modifications, additions, or omissions may be made to the method 200 without departing from the scope of the present disclosure. For example, the outlined steps and operations are only provided as examples, and some of the steps and operations may be optional, combined into fewer steps and operations, or expanded into additional steps and operations without detracting from the essence of the disclosed embodiments.

For example, the method 200 may further include obtaining an unseen data entry. The unseen data entry may include a set of features such as the features or columns included in the tabular dataset. For example, in instances an AI model is trained to detect medical conditions of patients, the unseen data entry may include information about a new patient. The AI model may be configured to generate predictions (e.g., presence of medical conditions) for the unseen data entry (e.g., the new patient).

In some embodiments, the only one of the first encoder and the second encoder may be used to generate the predictions during inference. For example, in some embodiments, only the first encoder (e.g., the GNN) may be used to generate the predictions. In these and other embodiments, as the first encoder and/or the second encoder are trained to reduce the total loss (e.g., reducing the consistency loss between the first set of embeddings and the second set of embeddings), using one of the first encoder or the second encoder may still generate improved predictions. Using only one of the first encoder or the second encoder may help the AI model generate predictions faster with reduced resources.

FIG. 3 illustrates a block diagram of an example computing system 300 that may be used with respect to a multi-modal training system, according to at least one embodiment of the present disclosure. For example, the computing system 300 may be used to implement multi-modal learning framework discussed with respect to FIGS. 1A-2.

The computing system 300 may include a processor 310, a memory 312, a data storage 314, and a user interface 316. The processor 310, the memory 312, the data storage 314, and the user interface may be communicatively coupled.

In general, the processor 310 may include any suitable special-purpose or general-purpose computer, computing entity, or processing device including various computer hardware or software modules and may be configured to execute instructions stored on any applicable computer-readable storage media. For example, the processor 310 may include a microprocessor, a central processing unit (CPU), a graphics processing unit (GPU), a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 4, the processor 310 may include any number of processors configured to, individually or collectively, perform or direct performance of any number of operations described in the present disclosure. Additionally, one or more of the processors may be present on one or more different electronic devices, such as different servers.

In some embodiments, the processor 310 may be configured to interpret and/or execute program instructions and/or process data stored in the memory 312, the data storage 314, or the memory 312 and the data storage 314. In some embodiments, the processor 310 may fetch program instructions from the data storage 314 and load the program instructions in the memory 312. After the program instructions are loaded into memory 312, the processor 310 may execute the program instructions.

The memory 312 and the data storage 314 may include computer-readable storage media for carrying or having computer-executable instructions or data structures stored thereon. Such computer-readable storage media may include any available media that may be accessed by a general-purpose or special-purpose computer, such as the processor 310. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 310 to perform a certain operation or group of operations.

The user interface 316 may include any device to allow a user to interface with the computing system 300. For example, the user interface 316 may include a mouse, a track pad, a keyboard, buttons, camera, and/or a touchscreen, among other devices. The user interface 316 may receive input from a user and provide the input to the processor 310.

Modifications, additions, or omissions may be made to the computing system 300 without departing from the scope of the present disclosure. For example, in some embodiments, the computing system 300 may include any number of other components that may not be explicitly illustrated or described.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Additionally, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B” even if the term “and/or” is used elsewhere.

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method comprising:
obtaining a tabular dataset;
converting, using a first converter, the tabular dataset into a first dataset having a first data type;
converting, using a second converter, the tabular dataset into a second dataset having a second data type different from the first data type;
generating, using a first encoder, a first set of embeddings in a first dimensional space based on the first dataset;
generating, using a second encoder, a second set of embeddings in a second dimensional space based on the second dataset; and
training one or both of the first encoder and the second encoder based on the first set of embeddings and the second set of embeddings.

2. The method of claim 1, wherein training one or both of the first encoder and the second encoder based on the first set of embeddings and the second set of embeddings comprises:
obtaining a labeled dataset including a set of target labels;
determining a first loss between the first set of embeddings and the second set of embeddings;
determining a second loss between the first set of embeddings and the labeled dataset;
determining a total loss based on the first loss and the second loss; and
updating one or more parameters of one or both of the first encoder and the second encoder based on the total loss.

3. The method of claim 2, wherein determining the second loss between the first set of embeddings and the labeled dataset comprises:
projecting the first set of embeddings to a third dimensional space corresponding to the labeled dataset;
mapping, using a classifier, the first set of embeddings to the set of target labels included in the labeled dataset; and
determining the second loss based on the mapping.

4. The method of claim 2, wherein the total loss is determined as a sum of the first loss and the second loss, the first loss and the second loss weighted differently based on a first weight and a second weight, respectively.

5. The method of claim 2, wherein the one or more parameters of only the first encoder is updated.

6. The method of claim 2, wherein determining the first loss between the first set of embeddings and the second set of embeddings comprises:
verifying that the first dimensional space matches the second dimensional space;
determining individual embeddings of the first set of embeddings corresponding to individual embeddings of the second set of embeddings; and
calculating distances between the individual embeddings of the first set of embeddings and the individual embeddings of the second set of embeddings.

7. The method of claim 1, wherein the first data type is graph data, and the second data type is textual data.

8. The method of claim 7, wherein the first encoder is a graph neural network, and the second encoder is an encoder part of a large language model.

9. The method of claim 7, wherein the first dataset includes one or more graphs representing relationships between feature columns of the tabular dataset.

10. The method of claim 7, wherein the second dataset includes the textual data representing semantic information of the tabular dataset.

11. The method of claim 1, wherein the tabular dataset includes numerical data and categorical data.

12. The method of claim 1, wherein a batch of the tabular dataset is converted into the first dataset and the second dataset.

13. One or more non-transitory computer-readable media storing instructions that, when executed by one or more processors, cause a system to perform operations, the operations comprising:
obtaining a tabular dataset;
converting, using a first converter, the tabular dataset into a first dataset having a first data type;
converting, using a second converter, the tabular dataset into a second dataset having a second data type different from the first data type;
generating, using a first encoder, a first set of embeddings in a first dimensional space based on the first dataset;
generating, using a second encoder, a second set of embeddings in a second dimensional space based on the second dataset; and
training one or both of the first encoder and the second encoder based on the first set of embeddings and the second set of embeddings.

14. The one or more non-transitory computer-readable media of claim 13, wherein training one or both of the first encoder and the second encoder based on the first set of embeddings and the second set of embeddings comprises:
obtaining a labeled dataset including a set of target labels;
determining a first loss between the first set of embeddings and the second set of embeddings;
determining a second loss between the first set of embeddings and the labeled dataset;
determining a total loss based on the first loss and the second loss; and
updating one or more parameters of one or both of the first encoder and the second encoder based on the total loss.

15. The one or more non-transitory computer-readable media of claim 14, wherein determining the second loss between the first set of embeddings and the labeled dataset comprises:
projecting the first set of embeddings to a third dimensional space corresponding to the labeled dataset;
mapping, using a classifier, the first set of embeddings to the set of target labels included in the labeled dataset; and
determining the second loss based on the mapping.

16. The one or more non-transitory computer-readable media of claim 14, wherein the total loss is determined as a sum of the first loss and the second loss, the first loss and the second loss weighted differently based on a first weight and a second weight, respectively.

17. The one or more non-transitory computer-readable media of claim 14, wherein the one or more parameters of only the first encoder is updated.

18. The one or more non-transitory computer-readable media of claim 14, wherein determining the first loss between the first set of embeddings and the second set of embeddings comprises:
verifying that the first dimensional space matches the second dimensional space;
determining individual embeddings of the first set of embeddings corresponding to individual embeddings of the second set of embeddings; and
calculating distances between the individual embeddings of the first set of embeddings and the individual embeddings of the second set of embeddings.

19. The one or more non-transitory computer-readable media of claim 13, wherein the first data type is graph data, and the second data type is textual data.

20. A system, comprising:
one or more processors; and
one or more non-transitory computer-readable storage media configured to store instructions that, in response to being executed, cause the system to perform operations, the operations comprising:
obtaining a tabular dataset;
converting, using a first converter, the tabular dataset into a first dataset having a first data type;
converting, using a second converter, the tabular dataset into a second dataset having a second data type different from the first data type;
generating, using a first encoder, a first set of embeddings in a first dimensional space based on the first dataset;
generating, using a second encoder, a second set of embeddings in a second dimensional space based on the second dataset; and
training one or both of the first encoder and the second encoder based on the first set of embeddings and the second set of embeddings.
